(19) United States
(12) Patent Application Publication
(10) Pub. No.: US 2026/0360138 A1
(43) Pub. Date: Nov. 12, 2026

(54) CONVERSATIONAL ARTIFICIAL INTELLIGENCE AGENT

(71) Applicant: Google LLC, Mountain View, CA (US)

(72) Inventors: Shahab Kamali, Portola Valley, CA (US); Vardhman Mehta, Santa Clara, CA (US); Shashank Bhushan, Sunnyvale, CA (US); Aidan Davis Oldershaw, San Francisco, CA (US); Alpa Jain, Los Altos, CA (US); Pallavi Satyan, Menlo Park, CA (US); Satyanarayana Shanmugam, Mountain View, CA (US); Senthil Kumar Hariramasamy, Los Altos, CA (US); Bhavika Goyal, Redwood City, CA (US); Rushil Grover, San Jose, CA (US)

(21) Appl. No.: 19/489,741

(22) PCT Filed: Nov. 13, 2024
(86) PCT No.: PCT/US2024/055727

§ 371 Date: Dec. 3, 2025

Related U.S. Application Data
(60) Provisional application No. 63/649,151, filed on May 17, 2024.

(51) Int. Cl. G06V 10/94; G06T 11/60; G06V 10/764; G06V 10/82; G06V 20/70

(52) U.S. Cl. CPC G06V 10/945; G06T 11/60; G06V 10/764; G06V 20/70; G06V 10/82

(57) ABSTRACT

Methods, systems, and apparatus, including computer programs encoded on a computer storage medium, for implementing a conversational artificial intelligence agent. Methods can include generating a digital component including a launch user interface element and establishing a communication channel with a client device at which the interaction with the launch user interface element occurred. A set of images are received from the client device. A list of objects depicted by the set of images are obtained from an image classification model. The set of images and text input previously submitted by the client device are analyzed by a language model. A description of objects in the set of images is created. A recommended offering is generated based on the description of the objects in the set of images. The recommended offering to the client device is transmitted over the established communication channel.

### CROSS-REFERENCE TO RELATED APPLICATION

This application claims priority to U.S. Provisional Application No. 63/649,151, filed on May 17, 2024. The disclosure of the prior application is considered part of and is incorporated by reference in the disclosure of this application.

### BACKGROUND

This specification relates to data processing and artificial intelligence agents.

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

In general, one innovative aspect of the subject matter described in this specification can be embodied in methods that include the actions of generating, by an artificial intelligence system, a digital component including a launch user interface element configured to invoke execution of a chat interface in response to user interaction with the launch user interface element; detecting, by the artificial intelligence system, interaction with the launch user interface element; establishing, by the artificial intelligence system, a communication channel with a client device at which the interaction with the launch user interface element occurred; receiving, by the artificial intelligence system and through the chat interface, a set of images from the client device; obtaining, from an image classification model, a list of objects depicted by the set of images; analyzing, by a language model, the set of images and text input previously submitted by the client device; creating a description of objects in the set of images based on (i) the list of objects obtained from the image classification model and (ii) the analysis of the set of images and text input; generating, by the artificial intelligence system, a recommended offering of a content provider based on the description of the objects in the set of images; and transmitting, by the artificial intelligence system, the recommended offering to the client device over the established communication channel.

These and other embodiments can each optionally include one or more of the following features. Methods can include generating a set of text reasons why the recommended offering of the content provider was provided; extracting a uniform resource locator from a second level domain of the content provider; extracting an image from the second level domain of the content provider; extracting resource text from the second level domain of the content provider; and generating the recommended offering based on a combination of the set of text reasons, the uniform resource locator, the image, and the resource text.

Creating the description of the objects can include generating a set of image/object description pairs, wherein each image/object description pair includes an image from the set of images and text specifying the objects depicted by the image.

Methods can include transmitting the set of image/object description pairs to the chat interface at the client device before creating the recommended offering; causing presentation, in the chat interface with the image/object description pairs, a continue user interface element; detecting interaction with the continue user interface element; and causing the chat interface to transition from a first state in which the image/object description pairs are presented to a second state in which the recommended offering is presented, wherein the transition is caused in response to detecting the interaction with the continue user interface element.

Methods can include inputting the image/object description pairs into a text language model, wherein generating the set of text reasons comprises obtaining, from the text language model, the set of text reasons why the recommended offering of the content provider was selected. Inputting the image/object description pairs into the text language model can be performed while the continue user interface element is presented in the chat interface and before interaction with the continue user interface element is detected.

Analyzing, by a language model, the set of images and the text input previously submitted by the client device can include generating, by the language model a summary output describing visual attributes depicted by the set of images. Methods can further include combining the summary output and the set of objects to create a combined description of the set of images.

This specification describes techniques for enabling an artificial intelligence (AI) agent to understand the contents of a user-submitted image (e.g., from a client device), and generate relevant information that is presented to the user. One of the technical challenges of implementing the AI agent is performing the image analysis/understanding and generating the relevant information in a “real-time” conversational environment. More specifically, the latency of generating information using a large language model increases with the size of the model, and the latency experienced using a large language capable of performing the image analysis/understanding and information generation can be in the range of 10's of seconds (e.g., 20 seconds or more). This latency is unacceptable in a real-time conversational environment, where responses are expected in less than 5 seconds. As such, a latency of 20 seconds or more would be at least 400% higher than the acceptable latency of 5 seconds or less.

One way to reduce the latency of a large language model is to use a smaller language model. However, use of a smaller language model negatively impacts the ability to accurately analyze/understand the image and generate information that is relevant to the image. Therefore, simply using a smaller language model to achieve the target latency (e.g., 5 seconds or less) will result in a system that is more likely to generate irrelevant information, which is counter-productive and wastes computing resources. Generally speaking, the size of a language model is evaluated/determined based on the number of parameters used by the model, with smaller models using fewer parameters than larger models.

As discussed throughout this specification, the target latency can be achieved while ensuring that the system accurately analyzes/understands the image, and therefore, generates relevant information by using a combination of (i) a language model that can meet the target latency and (ii) an image classification model (e.g., an object detection model). For example, as discussed in more detail below, the image classification model can be used to identify objects in the image, and the language model can be used to analyze the image, and generate an understanding of (e.g., a textual output summarizing) the contents of the image using the analysis performed by the language model, the set of objects identified by the image classification mode, and text input submitted by the user (e.g., through a client device). In this way, the low-latency language model can use the accurate object detection provided by the image classification model, which is generated in less than 500 ms, to ensure that the language model does not miss objects that are depicted by the image, thereby ensuring accuracy, while still meeting the target latency. Thus, combining the image classification model with a low-latency (e.g., smaller) language model overcomes the technical problem of generating relevant information based on an input image within a “real-time” latency constraint.

Another technical problem faced when creating a system that can perform the analysis/understanding/information generation is the ability to quickly improve the model and/or add new detectable objects. For example, if a deep neural network (e.g., convolutional neural network) were solely used to implement the image classification model, as is common, updates to the model would require the full model (e.g., all layers) to be retrained, which requires a lot of time and computing resources. To the contrary, using a simpler classification model (e.g., shallow classifier model), which is easier/faster to train, results in a less robust object classification capabilities (e.g., fewer objects identifiable by the model). To overcome these challenges, the system discussed herein fuses a shallow classifier model with a deep image embedding network, resulting in a hybrid classification model that only requires the top level of the model to be updated when new objects are added, while utilizing the deep embeddings of a neural network that detection of a wide range of objects. In some implementations, a saddle classifier model (e.g., a three-layer model) is trained on top of the deep embedding model, which is frozen (e.g., not updated), such that when the saddle classifier is retrained, only tens of examples are needed, rather than the thousands of examples that would be needed to retrain a convolutional neural network. This enables the hybrid model discussed herein to be retrained in hours instead of days. As such the resulting system is more efficient and flexible relative to solely using a convolutional neural network, while still enabling robust object detection capabilities provided by a convolutional neural network.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an artificial intelligence system can be implemented.

FIG. 2 is a block diagram illustrating interactions that facilitate the automated analysis, understanding, and information generation using a combination of models.

FIG. 3 is an illustration of a user experience interacting with a conversational artificial intelligence agent.

FIG. 4 is a flow chart of an example process for performing automated analysis, understanding, and information generation using a combination of models.

FIG. 5 is a block diagram of an example computer.

Like reference numbers and designations in the various drawings indicate like elements.

### DETAILED DESCRIPTION

This specification describes techniques for enabling an artificial intelligence (AI) system to operate as a conversational artificial intelligence agent. As discussed in detail below, the chat interface through which the conversational AI agent communicates with a user is launched at a client device and establishes a communications channel with the AI system. The chat interface can be launched, for example, through user interaction with a launch user interface element (e.g., a chat button) that is configured to invoke execution of the chat interface, and can be embedded, for example, in a digital component that was presented at the client device. The AI system receives a set of images from the client device and uses these images to obtain a list of objects depicted by the set of images. For example, the set of images can be provided to an image classification model that is configured to detect specific objects in the set of images and/or a language model that is configured to analyze the set of images and generate a description of the images, including the objects that are depicted by the images. The latency of using a larger language model, which has more parameters than a smaller language model, is generally higher than the latency constraint within which a real-time chat interface needs to operate. For example, the latency of generating content with a larger language model can be in the range of 20 seconds, while the latency constraint of generating content in a real time chat interface may be 5 seconds. However, combining the image classification model, which can have a latency of approximately 500 ms, with a smaller language model (e.g., a model with a latency of less than the latency constraint) enables the present solution to generate responses to user input in a real-time chat environment, while still providing an accurate evaluation of the set of images.

A description of the set of images is generated based on a list of objects obtained from the image classification model and the analysis of the set of images by the language model. That description is used to generate a recommended offering that is presented at the client device (e.g., in the chat interface). In some situations, previously submitted text (e.g., a search query previously submitted by the client device) can also be used to generate the description of the set of images and/or the recommended offering.

As used throughout this document, the phrase “digital component” refers to a discrete unit of digital content or digital information (e.g., a video clip, audio clip, multimedia clip, gaming content, image, text, combination of image and text, bullet point, artificial intelligence output, language model output, or another unit of content or unit of combined content). A digital component can electronically be stored in a physical memory device as a single file or in a collection of files, and digital components can take the form of video files, audio files, multimedia files, image files, or text files and include advertising information, such that an advertisement is a type of digital component.

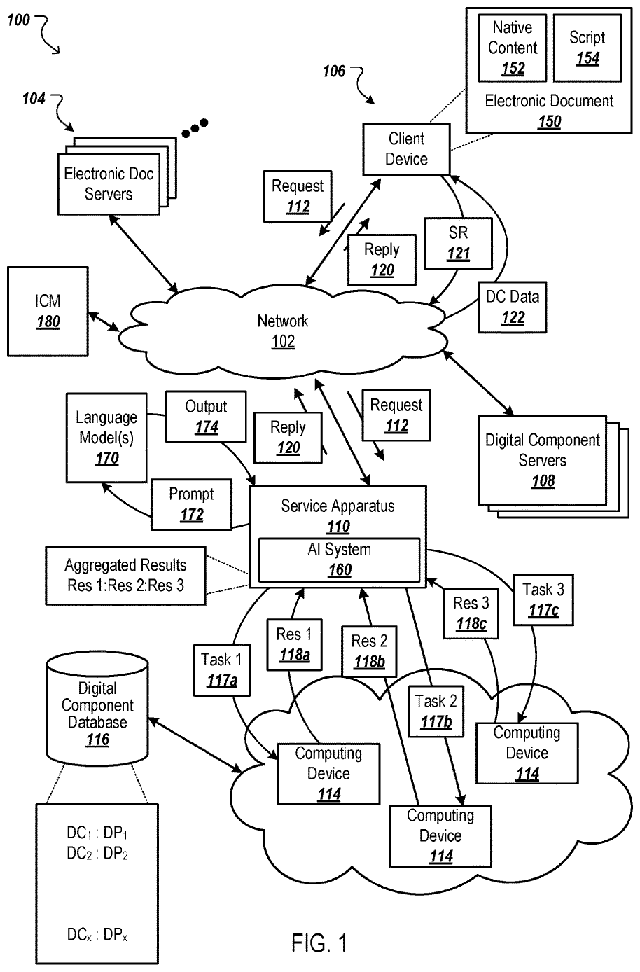

FIG. 1 is a block diagram of an example environment 100 in which generative artificial intelligence can be implemented. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, tablet devices, digital assistant devices, augmented reality devices, virtual reality devices, wearable devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords/topics/categories that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160 configured to autonomously generate digital components, either prior to a request 112 (e.g., offline) and/or in response to a request 112 (e.g., online or real-time). The artificial intelligence (“AI”) system 160 can collect online content about a specific entity (e.g., digital component provider or another entity) and summarize the collected online content using one or more language models 170, which can include large language models of various sizes. Note that the language model 170 is depicted as being separate from the service apparatus 110 and the AI system 160, but the language model 170 can be integrated into the service apparatus 110 and/or the AI system 160.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, recommendations, and code.

The category of “large language models” can vary in size. Larger models generally use a larger number of parameters than smaller models, which enables the larger models to complete a wider range of tasks and generate more accurate responses to input. For example, because of the larger number of parameters, the larger language models are generally configured to understand the context of the input more effectively, and to generate more detailed responses than smaller models that use a smaller number of parameters.

Although larger language models are generally more flexible and more accurate than smaller models, these additional capabilities also require significantly more computational resources, including more powerful and/or a larger number of Graphics Processing Units (GPUs) or Tensor Processing Units (TPUs) to train and deploy (e.g., operate) than smaller language models. For example, a larger language model can require 20 seconds or more to generate a response to an input, while a smaller language model can be configured to generate a response in less than 5 seconds. Furthermore, larger language models can require significantly more memory to train and/or deploy. As described in more detail throughout this specification, a smaller language model can be combined with another model (e.g., an object detection model) to improve the quality of the output of the smaller language model without incurring the additional latency associated with using a larger language model. As such, outputs similar to those provided by larger language models can be achieved in less time than possible using a larger language model alone.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution (e.g., a probability distribution) that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

The environment 100 also includes an image classification model (“ICM”) 180, which is configured to identify and/or classify objects in images. For example, the image classification model 180 can be configured to accept, as input, a set of images, evaluate the set of images, and output label (e.g., text) identifying one or more objects in the set of images. In some implementations, the ICM 180 may be a collection of models that are each trained to identify objects in different categories of objects. For example, one model in the ICM 180 can be trained to identify sports objects (e.g., baseball, football, hockey stick, etc.), while another model in the ICM 180 can be trained to identify household items (e.g., lamps, couches, tables, appliances, etc.). In some implementations, the ICM 180 can parallel process an image using multiple models (e.g., for different categories) to reduce the latency relative to serial processing, while still obtaining labels from different categories.

The ICM 180 can be initially trained/created using known image classification model techniques (e.g., supervised learning) to create a deep convolutional neural network (“CNN”). In this way, the creation of the ICM 180 results in a deep image embedding network that allows for accurate classification of a wide range of objects with minimal latency (e.g., 300 ms). However, if the deep CNN/image embedding network needs to be updated, all levels of the CNN need to be retrained, which takes substantial computing resources and time. For example, the training/retraining of a CNN image classification model can take weeks to retrain and a large set of training data (e.g., millions of samples). This latency can be unacceptable in many situations, particularly in situations where the model is being retrained to identify new objects that were not covered by the original CNN.

To overcome the downside to using a traditional CNN in the present environment 100, the ICM 180 can be implemented using (i) the deep image embedding network generated from the original training of the ICM 180 (e.g., the creation of the CNN) and (ii) a shallow classifier model. In some implementations, the shallow classifier model is fused to the deep image embedding network, which is frozen post training. That is, once the deep image embedding network has been created, the embedding layers can be frozen such that they are not changed going forward, and the shallow classifier can be implemented on top of that deep embedding network. In a specific example, the deep image embedding network can be a starburst embedding network, and the shallow classifier can be a saddle classifier model (or another shallow classifier model) that is on top of the starburst embedding network. In this example, the saddle classifier can be a three-layer model, which can be retrained within hours (rather than weeks), using a training set on the order of 10's of examples. As such, the ICM 180 can be retrained very quickly to reduce the time required to retrain the ICM 180 to identify new objects, thereby enabling the updated ICM 180 to be deployed more quickly than if the entire CNN needed to be retrained. Meanwhile, the saddle classifier still benefits from the frozen (e.g., non-changed) deep image embedding network that was originally created by traditional image classification model training techniques. The ICM 180 is shown as separate from the AI system 160 and the language model 170, but any of these components can be combined.

The combination of devices/apparatus discussed above can be used to implement a conversational AI agent that is configured to obtain information from the client device 106, process that information, and generate a recommended offering of a content provider that is transmitted to the client device 160. The way in which the devices/apparatus are combined/configured enables the interactions between the client device 106 and the AI system 160 to be fluid in nature, much like the manner in which two humans would interact. That is, the manner in which the models are implemented reduce the latency required to provide information back to the client device 106 after obtaining information from the client device. For example, responses generated by the AI system 160 and provided to the client device in response to the submission of information can be achieved in less than 5 seconds, while generating information that would typically require 20 seconds or more if implemented using only a larger language model.

In operation, the service apparatus 110 (and AI system 160) can receive a request 112 and provide the client device 106 with the digital component data 122. The digital component data 122 can include code that causes the client device 106 to present a “launch” user interface element within a digital component. The launch user interface element is a user interface element that invokes execution of a chat interface in response to user interaction with the launch user interface element. For example, the launch user interface element can be a chat button that is presented within the digital component. Upon interaction with the chat button, the client device 106 can transmit data to the service apparatus 110, which causes the service apparatus 110 to detect the interaction with the chat button and establish a communication channel with the client device 106. By way of this communication channel, the client device 106 can submit information to the service apparatus 110, and the service apparatus 110, which includes the AI system 160, can generate a response, which is then transmitted to the client device 106 and presented, for example, in the chat interface. Note that the AI system 160 is part of the service apparatus 110, such that operations described as being performed by the service apparatus 110 can also be performed by the AI system 160. In other words, the service apparatus 110 could be considered part of the AI system 160 even though the AI system 160 is depicted as a component of the service apparatus 110.

As described in more detail with reference to the figures that follow, the client device 106 can use the chat interface to upload a set of images to the service apparatus 110. The service apparatus 110 can then use the ICM 180 to obtain a list of objects depicted by the set of images. For example, the ICM 180 can analyze the set of images, identify objects depicted by the set of images, and generate a set of labels that lists the objects depicted by the set of images. The ICM 180 can transmit this list of objects back to the service apparatus 110.

The service apparatus 110 can also provide the set of images to the language model 170 for analysis. For example, the service apparatus 110 (e.g., by way of the AI system 160), can generate a prompt that instructs the language model to generate a description of the set of images, and transmit (or otherwise provide) the prompt and the set of images to the language model 170. The language model 170 will use the prompt and the set of images to generate a contextual description of the set of images and output a response describing the set of images. In some implementations, the list of objects identified by the ICM 180 can also be provided to the language model 170, which can also be used by the language model 170 to generate the description of the images.

Furthermore, text previously submitted to the service apparatus 110 by the client device 106 can also be provided to the language model 170 as contextual information the language model 170 can use to generate the description of the images. For example, assume that the client device 106 has previously submitted the search query “move to Atlanta”, which was received by the service apparatus 110. In this example, the previously submitted search query can be provided to the language model 170 to provide context in which the images should be evaluated. More specifically, since the search query is related to moving to a particular city, the language model can use this information as context for evaluating the images and generating descriptions of objects in the images. Continuing with this example, assume that the set of images depict images of an apartment that is filled with furniture.

Given this context, the language model 170 may determine that the user of the client device is interested in moving to Atlanta, and that the objects in the images are objects that would need to be transported from the apartment to Atlanta. Given this context, the language model may focus on describing the movable objects located in the apartment (e.g., table, chairs, etc.), rather than immovable objects or fixtures (e.g., lights, windows, walls, faucets, dishwashers, etc.). In this way, providing the language model 170 is text previously submitted by the client device 106 can result in a description of objects in the images that is more relevant to the task/activity being contemplated/researched by the user of the client device 106.

The AI system 160 can use the description of the images to generate a recommended offering that is relevant to the description of objects in the images in the context of the digital component in which the launch user interface element was presented. For example, assume that the digital component was provided by a given content provider that offers moving services. In this example, the AI system 160 can use information obtained about the moving services provided by the content provider and the description of the objects in the set of images. In a specific example, the AI system 160 can determine, based on the description of the objects in the images a size of a moving truck that would be needed to move the objects, a price of renting the moving truck, and an availability of the moving truck, which could be combined in a new digital component that is transmitted to the client device, and presented in the chat interface. In this way, the service apparatus 110/AI system 160 can collect the information needed to help guide the user to the appropriate information, particularly in situations where the user may not know what they need to achieve the desired goal (e.g., moving the items in their apartment to a new location). The operations performed to generate the recommended offering, and how the latency of generating such a recommended offering is reduced (e.g., relative to simply using a larger language model) is discussed in more detail below. Techniques for helping ensure that information in the recommended offering is accurate are also discussed below.

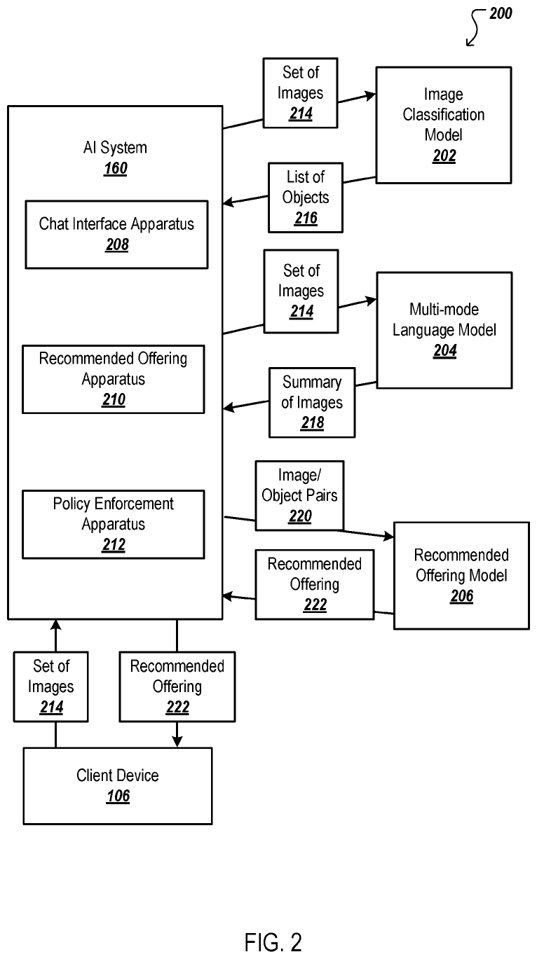

FIG. 2 is a block diagram 200 illustrating interactions that facilitate the automated analysis, understanding, and information generation using a combination of models. As shown, the combination of models can include an image classification model 202 and a multi-mode language model 204, and a recommended offering model 206. The image classification model 202, multi-mode language model 204, and the recommended offering model 206 are shown as being implemented outside of the AI system 160, but some or all of these models can be implemented within the AI system 160, and in either case, the interactions between the AI system 160 and the models is considered an incorporation of the models into the AI system 160. Furthermore, the models 202, 204, and 206 can be implemented in the service apparatus 110 of FIG. 1 with the AI system 160. As shown, the AI system 160 includes a chat interface apparatus 208, a recommended offering apparatus 210, and a policy enforcement apparatus 212, which will each be described in more detail below. As noted above, the service apparatus 110 and the AI system 160 can be implemented together, such that operations discussed as being performed by the AI system 160 can also be considered performed by the service apparatus 110, and vice versa. For brevity, description of FIG. 2 that follows discusses operations being performed by the AI system 160, rather than the service apparatus 110.

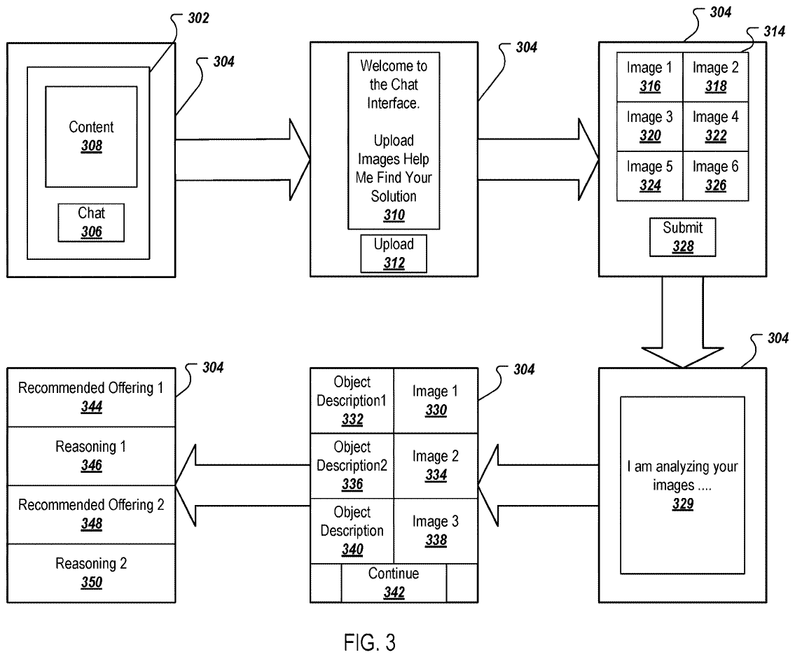

In operation, the AI system 160 receives a set of images 214 from a client device 106. As discussed above, the set of images 214 can be submitted to the AI system 160 by the client device by way of a chat interface. For example, as discussed in more detail with reference to FIG. 3, the chat interface can be implemented to facilitate the selection and submission of a set of images 214 selected by the user of the client device. For purposes of example, assume that the set of images 214 are images depicting objects in rooms of a dwelling. In this example, the set of images 214 can be received by the chat interface apparatus 208 of the AI system.

The chat interface apparatus 208 is implemented by one or more processors and is specially programmed to establish a communications channel with the client device 106 in response to detecting interaction with a launch user interface element at the client device 106. For example, as discussed above, the launch user interface element can be a chat button that is presented in a digital component provided by a content provider. The chat interface apparatus 208 can also be configured to receive information submitted through the chat interface instantiated at the client device 106, and to transmit, to the client device 106, responses that are presented in the chat interface. A series of interactions between the AI system 160 and client device are enabled by way of the chat interface apparatus 208, the communications channel established by the chat interface apparatus 208, and the chat interface instantiation invoked at the client device 106.

The chat interface apparatus 208 can pass the set of images 214 to the image classification model 202. The image classification model 202 can be configured and function in a similar manner as the image classification model 180 discussed above with reference to FIG. 1. For example, the image classification model 202 can be a fusion (e.g., combination) of a deep image embedding network that was part of an initial training of the image classification model 202, and then fixed, and a shallow classifier model (e.g., three layers) that can be quickly retrained while still leveraging the fixed deep image embedding network.

The image classification model 202 processes the set of images 214 and generates a list of objects 216. The list of objects are objects that the image classification model 202 identified in the set of images 214. For example, assuming that images depicting objects in rooms of a dwelling were provided to the image classification model 202, the list of objects 216 may include a couch, a table, a chair, or other items that are depicted by the set of images 214.

The AI system 160 can provide the set of images 214 to the multi-mode language model 204 for evaluation. The multi-mode language model 204 is a language model, similar to the language model 170 of FIG. 1, that is trained/configured to generate an output based on text and image input. As such, the multi-mode language model 204 can generate a description of the set of images 214 based on the objects depicted by the set of images 214, as well as any text input that is provided to the multi-mode model 204.

In some implementations, the AI system 160 will provide text input (or otherwise provide), including (i) the list of objects 216 and/or (ii) text previously received from the client device 106, to the multi-mode language model 204. The text input is used by the multi-mode language model 204 to provide a context in which the multi-mode language model (MMLM) 204 will describe the set of images. For example, as discussed above, the text previously submitted by the client device 106 can include previous search queries, such as the search query that triggered presented of the digital component containing the launch user interface element, other prior search queries, or other text received from the client device 106 (e.g., through the chat interface).

The MMLM 204 uses the set of images 214 and any text input to generate a summary of images 218. The summary of images 218 can be a text output that describes the objects depicted by the set of images 214, relative orientations of the objects, sizes of the objects, and/or other characteristics of the images (e.g., fragile, expensive, etc.). In some implementations, the summary of images 218 includes a single summary of multiple images. That is, the MMLM 204 can evaluate the set of images 214 in aggregate and generate a single aggregate summary of objects depicted by all images (or two or more of the images) in the set of images 214. For example, assume that the set of images includes five different images. In this example, the MMLM 204 can evaluate all five images, and generate a single summary of the objects depicted by the five images.

In some implementations, the summary of images 218 includes a separate summary for each image in the set of images 214. For example, when the set of images 214 includes five different images, as discussed in the example above, the summary of images 218 can include five different summaries, with each summary corresponding to one of the different images. In these situations, each summary can include data specifying (or otherwise referencing) the image for which the summary was created. For example, the summary of the images, which can also be referred to as a description of the objects in the images, can be created by generating a set of image/object pairs 220. Each of the image/object pairs 220 can include an image from the set of images 214 and text specifying objects depicted by the image. In the example above, the MMLM 204 would create five different image/object pairs 220 that would be provided (e.g., transmitted) to the AI system 160 as the summary of images 218.

The AI system 160 receives the summary of images 218 from the MMLM 204, and, in some implementations, transmits the summary of images 218 to the client device 106. For example, the AI system 160 can transmit the summary of images (e.g., the set of image/object description pairs 220) to the client device by way of the chat interface invoked at the client device before proceeding to select a digital component (e.g., a recommended offering) using the summary of images 218. In this way, the AI system 160 can obtain input from the user of the client device 106 regarding the accuracy of the summary of images 218. For example, when the AI system 160 transmits a set of image/object description pairs, the AI system 160 can include text (or another indication) requesting the user to verify that the descriptions are accurate, and requesting the user to interact with a continue user interface element as an indication that the user would like to proceed with the chat interaction based on the image/object description pairs 220. In this way, the AI system 160 can prevent invoking computing resources required to generate a digital component (e.g., recommended offering) in situations where the summary of images 218 is not accurate. As such, the computing resources will not be wasted.

Upon detecting interaction with the continue user interface element, the AI system 160 can transmit the set of image/object description pairs to the recommended offering model 206. The recommended offering model 206 is configured to use the image/object description pairs 220 to generate a recommended offering. In some implementations, only the descriptions of the objects in the image/object description pairs 220 need be provided to the recommended offering model 206, while in other implementations, both the image and the object descriptions are provided to the recommended offering model 206. In either case, the recommended offering model 206 can use the received information to generate a recommended offering 222 of a content provider.

Rather than transmitting input (e.g., the image/offering pairs 220) to the recommended offering model 206 in response to detecting interaction with the continue user interface element, the AI system 160 can be configured to transmit input (e.g., the image/object pair descriptions) to the recommended offering model 206 while the continue user interface element is presented in the chat interface at the client device 106. In this way, generation of the recommended offering 222 can be initiated before interaction with the continue user interface element is detected. Transmitting the input to the recommended offering model 206, and initiating generation of the recommended offering, before detecting interaction with the continue user interface element results in a more seamless chat interaction between the AI system 160 and the client device 106. More specifically, initiating generation of the recommended offering 222 prior to detecting interaction with the continue user interface element allows for a portion of the model latency to be hidden by the fact that the AI system 160 is waiting for the user's input, rather than the user waiting on the response from the AI system 160. In this way, the amount of time that elapses between detecting interaction with the continue user interface element and the transmission of the recommended offering 222 to the client device 106 will be shorter than if the input to the recommended offering model 206 were only transmitted after detecting interaction with the continue user interface element.

In some implementations, the recommended offering model 206 can be a language model (e.g., a text language model) that generates the recommended offering 222 as well as a text description specifying why the recommended offering 222 is being provided to the client device. For example, assume that the image/object description pairs 220 specify types of furniture that depicted by the set of images, relative sizes of the objects, etc. In this situation, the recommended offering model 206 may create a recommended offering specifying a size of truck that would be needed to move all of the identified objects, a price for the truck, and an availability of the truck. Furthermore, the recommended offering model 206 could create a set of text reasons why the recommended offering 222 was provided to the client device. More specifically, the recommended offering model 206 could indicate that the recommended truck size will fit all of the objects identified in the set of images 214, and that the truck is available for rental in the next two weeks. In this way, an explanation of the output of the recommended offering model 206 is provided to the user to clarify why a specific offering is being presented to the user.

In some implementations, the recommended offering model 206 can generate the recommended offering and the text reasons why the recommended offering 222 was provided based on information obtained from online resources of the content provider for which the recommended offering 222 was provided. For example, the AI system 160 and/or recommended offering model 206 can access a second level domain of the content provider and extract various information, such as a uniform resource locator of the second level domain, an image resources text, or other content that is available from the second level domain of the content provider. In this way, the AI system 160 and/or recommended offering model 206 can have a high level of confidence that the information is factually accurate since it is being extracted from the second level domain of the content provider for which the recommended offering is being generated. In operation, the recommended offering model 206 can generate the recommended offering 222 to include a combination of the set of text reasons why the recommended offering 222 is being provided, the uniform resource locator of the second level domain of the content provider, an image of the recommended offering 222, and/or text from the resource located at the second level domain of the content provider.

The AI system 160 transmits the recommended offering 222 to the client device 106 over the communication channel established in response to the interaction with the launch user interface element that was presented in the digital component and invoked execution of the chat interface at the client device 106. The client device 106 receives the recommended offering 222 and presents the recommended offering 222 in a display. In some implementations, the recommended offering 222 can be presented in the chat interface that was invoked in response to interaction with the launch user interface element.

In some implementations, transmission of the recommended offering 222 to the client device 106 causes the chat interface invoked at the client device 106 to transition from a first state in which the image/object description pairs are presented to a second state in which the recommended offering is presented. In other implementations, the transition from the first state to the second state is caused in response to detecting the interaction with the continue user interface, and the recommended offering 222 is then presented.

The policy enforcement apparatus 212 of the AI system 160 can be invoked at various points along the interactions discussed above. For example, the policy enforcement apparatus 212 can be invoked to ensure that the list of objects 216 does not contain any blocklisted (e.g., prohibited) terms and/or that the list of objects 216 only includes a set of allowed terms. In this way, the policy enforcement apparatus 212 can help ensure that the information provided to the client device 106 (e.g., by way of the chat interface) does not violate policies of the AI system 160 and/or does not include content that is inappropriate for distribution to the client device 106 (e.g., as specified by an administrator of the AI system 160). In some implementations, the policy enforcement apparatus 212 can also be invoked to examine the summary of images 218 in a manner similar to the list of objects. Furthermore, the policy enforcement apparatus 212 can be invoked to evaluate the recommended offering 222 that is generated by the recommended offering model 206. The evaluation of the recommended offering 222 can include similar safety checks as those discussed above, as well as checks to ensure that the recommended offering is formatted in accordance with the requirements of the AI system 160. For example, the policy enforcement apparatus 212 can ensure that the recommended offering has an appropriate size, uses approved fonts, and includes information matching that found in the second level domain of the content provider for whom the recommended offering 222 was generated. In this way, the policy enforcement apparatus 212 can ensure that the recommended offering 222 will fit in the chat interface at the client device 106, and does not include other policy violations, prior to transmitting the recommended offering 222 to the client device 106. This prevents wasted bandwidth by not transmitting content that ultimately will not fit in the allotted space, or otherwise will be prevented from presentation by the client device 106, which would be possible if the recommended offering 222 were not evaluated by the policy enforcement apparatus 212 of the AI system 160.

FIG. 3 is an illustration of a user experience interacting with a conversational artificial intelligence agent. The user experience can begin with the presentation of a digital component 302 that is presented in a user interface 304 at a client device. The digital component 302 can be, for example, a pre-existing digital component that is selected for presentation as discussed above with reference to FIG. 1. The digital component can alternatively be a digital component that is generated dynamically based on information contained in a request, as discussed above with reference to FIG. 1. In either case, the digital component 302 is generated to include a launch user interface element, which is shown as the chat button 306. The digital component 302 can also include other content, such as information about a content provider for whom the digital component was provided.

Interaction with the chat button 306 (e.g., the launch user interface element) results in a chat interface 310 to be launched/instantiated in the user interface 304. The chat interface 310 can include instructions guiding the user how to obtain more information that will assist the AI system 160 (not shown) in creating an appropriate recommended offering. For example, as shown, the chat interface 310 instructs the user to upload images to assist in finding a solution for the user. The user interface 304 also includes an upload user interface element 312, which can be used to invoke, launch, or otherwise instantiate an image upload interface. For example, upon detecting interaction with the upload user interface element 312, the user interface can be updated to present an image selection interface 314. The images 316-326 presented in the image selection interface 314 can be images contained in an image database on the client device. For example, assume that the user has taken pictures of several rooms containing furniture that needs to be moved. In this example, the images 316-326 can be the pictures of the rooms containing furniture.

The image selection interface 314 can be configured to enable the user selection of any of the images (e.g., one or more of the images), for example, through user interaction with the images 316-326. Once the user has selected a set of the images, interaction with the submit button 328 will initiate uploading of the set of images, as discussed above with reference to the set of images 214 (FIG. 2). The submit button 328 is an example of an upload user interface element that is configured to upload a set of images in response to interaction with the submit button 328.

While the set of images are being evaluated (e.g., by the image classification model 202 and/or the multi-mode language model 204 of FIG. 2), the user interface can transition to a waiting state in which the user is presented a wait message 329 indicating that the images are being analyzed. As discussed above, combining the image classification model with a smaller language model results in a P90 latency of 5 seconds or less (indicating that the output of the models will be presented to the user in less than 5 seconds 90% of the time). As such, the wait message 329 is expected to be presented for 5 seconds or less for 90% of the user uploads of images.

Once the set of images have been evaluated by the image classification model 202 and/or the multi-mode language model 204, as discussed above with reference to FIG. 2, the user interface 304 presents a set of image/object description pairs similar to those discussed above with reference to FIG. 2. For example, the user interface 304 is shown presenting the images 330, 334, and 338, and corresponding object descriptions 332, 336, and 340. As shown, the object descriptions 332, 336, and 340 that describe objects of the images 330, 334, and 338, are positioned horizontally adjacent to the image described, such that each object description and corresponding image that are horizontally adjacent constitute an image/object description pair.

The user interface 304 includes a continue button 342 that is presented with the image/object description pairs. The continue button 342 is an example of a continue user interface element that is configured to submit (e.g., to the AI system 160 of FIGS. 1-2) data indicating that the user would like to proceed with the interactions using the presented image/object description pairs. In some implementations, interaction with the continue button 342 causes the object descriptions 332, 336, and 340 to be submitted to the recommended offering model 206 of FIG. 2. In some implementations, the object descriptions 332, 336, and 340 are submitted to the recommended offering model 206 of FIG. 2 while the object descriptions 332, 336, and 340 are presented in the user interface 304 with the continue button 342. In these implementations, processing of the object descriptions 332, 336, 340, and/or the images 330, 334, and 338 can be performed by the recommended offering model 206 while the system is waiting on interaction with the continue button 342. In this way, the creation of the recommended offering 344 can be initiated while waiting for the user to interact with the continue button 342, thereby reducing the latency (e.g., amount of time) between the interaction with the continue button 342 and the subsequent presentation of the recommended offering 344 in the user interface 304. Note that the images 330, 334, 338, and/or text previously submitted by the client device (e.g., prior search queries) can also be submitted with the object descriptions 330, 334, 338, and used to generate the recommended offerings 344, 348.

Interaction with the continue button 342 causes the user interface 304 (e.g., the chat interface 310) to transition from a first state in which the image/object description pairs are presented to a second state in which the recommended offering 344 is presented. In some implementations, multiple recommended offerings 344 and 348 can be presented in the user interface at the second state. Additionally, each recommended offering 344, 348 can include, or otherwise be presented with a corresponding reasoning 346, 350 explaining why the recommended offering 344, 348 of the content provider was selected. For example, assuming that the content provider provides rental moving trucks, the recommended offerings 344, 348 can depict and/or describe two different sized moving trucks offered by the content provider. In this example, the reasoning 346, 350 for each of the recommended offerings 344, 348 can explain why each size moving truck was offered. For instance, the reasoning 346 for a particular sized moving truck may explain that the particular sized moving truck is large enough to hold the set of items identified in the object descriptions 332, 336, and 340. Meanwhile, the reasoning 350 for a larger sized moving truck may explain that the larger sized moving truck will hold all of the items identified in the object descriptions 332, 336, and 340, as well as other common items that may not have been identified in the object descriptions 332, 336, and 340, but are common items to be moved (e.g., patio furniture).

Each of the recommended offerings 344 and 348 can include information collected from the second level domain of the content provider referenced by (e.g., linked to) by the recommended offerings 344 and 348. For example, assume that the second level domain of the content provider is example.com/movers. In this example, the recommended offerings 344 and 348 can include moving truck sizes/descriptions, pricing, and/or availability of the trucks offered. In this way, the information is more likely to be accurate because the information was obtained directly from the second level domain of the content provider, rather than from another unrelated online resource (e.g., that is not in the second level domain of the content provider. The recommended offerings 344 and 348 can also link to the second level of the content provider, thereby facilitating user access to the second level domain of the content provider and any information contained therein through interaction with the recommended offerings 344, 348. The recommended offerings 344, 348 are additional examples of digital components, which are dynamically generated during the interactions between the client device and the AI system 160.

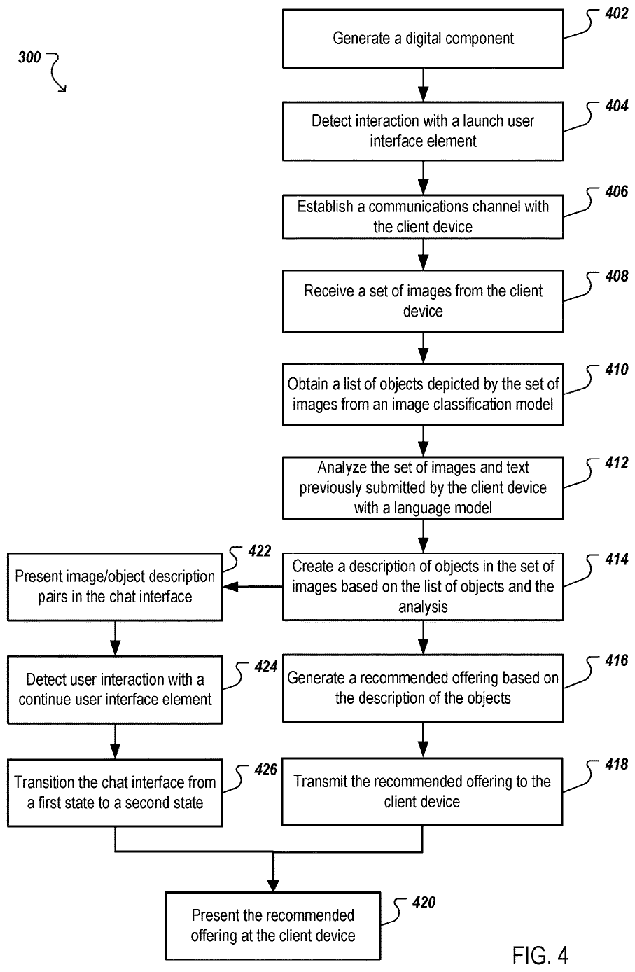

FIG. 4 is a flow chart of an example process 400 for performing automated analysis, understanding, and information generation using a combination of models. Operations of the process 400 can be performed, for example, by the service apparatus 110 of FIG. 1 (e.g., including the AI system 160 and/or language model 170), or another data processing apparatus. The operations of the process 400 can also be implemented as instructions stored on a computer readable medium, which can be non-transitory. Execution of the instructions, by one or more data processing apparatus, cause the one or more data processing apparatus to perform operations of the process 400.

A digital component is generated (402). In some implementations, the digital component is generated to include a launch user interface element. The launch user interface element is configured to invoke execution/instantiation of a chat interface in response to interaction with the launch user interface element. For example, as discussed with reference to FIG. 3, the chat button 306 is an example of a launch user interface element. In some implementations, the digital component can be generated prior to receipt of a request for content. In some implementations, the digital component is generated dynamically in response to receiving a request for content. The digital component can be selected for presentation at a client device based on contents of the request (e.g., a search query submitted from the client device), as discussed in detail with reference to FIG. 1. The digital component is transmitted to the client device, and instructions included in the digital component cause the client device to present the digital component in a user interface of the client device.

Interaction with the launch user interface element is detected (404). In some implementations, the interaction with the launch user interface is detected based on data/instructions received from the client device in response to the interaction with the launch user interface element. For example, interaction with the chat button 306 of FIG. 3 can cause the client device to generate and/or submit data to the AI system 160 indicating that the user interacted with the chat button 306.

A communication channel is established with a client device at which the interaction with the launch user interface element occurred (406). In some implementations, the communication channel is established through an exchange of information between the client device and a server (e.g., the service apparatus 110 and/or AI system 160). For example, client device and sever can exchange sufficient information (e.g., a device identifier, internet protocol address, or other information) that enables messages to be exchanged by the devices. The information can be exchanged, for example, using an application programming interface (API).

A set of images are received from the client device (408). In some implementations, the set of images are submitted through, and received from, the chat interface at the client device. For example, as discussed above with reference to FIG. 3, the chat interface can present an image selection interface that facilitates user selection of a set of images (e.g., from a corpus of stored images), and submission/transmission of the set of images to a server device (e.g., the service apparatus 110, the AI system 160, and/or another data processing apparatus).

A list of objects depicted by the set of images is obtained (410). In some implementations, the list of objects is obtained from an image classification model. For example, as discussed above with reference to FIG. 2, the image classification model can be a fusion (e.g., combination) of a deep image embedding network that was part of an initial training of the image classification model 202, and then fixed, and a shallow classifier model (e.g., three layers) that can be quickly retrained while still leveraging the fixed deep image embedding network. In some implementations, the image classification model is configured with an allowed list of objects that are able to be detected and/or listed in the list of objects. For example, the image classification model can identify objects in the set of images and compare the identified objects against the allowed list of objects. When a given identified object is not found in the allowed list of objects, the image classification model can omit that given identified object from the list of objects that is obtained from the image classification model.

In some implementations, the image classification model generates a complete list of all objects identified in the set of images, which can be evaluated by a policy enforcement apparatus 212, as discussed above with respect to FIG. 2. In these implementations, the policy enforcement apparatus 212 can use the allowed list of objects in a manner similar to that described above to identify items from the complete list that are not included in the allowed list of objects, and filter those objects out (e.g., remove those items), to obtain a filtered/approved list of objects. In some implementations, the policy enforcement apparatus can use a blocklist, which can be used to search the complete list generated by the image classification model and/or the objects not identified in the allowed list of objects. In these implementations, objects that match an item in the blocklist can be removed (e.g., filtered), such that the obtained list of objects does not include objects included in the blocklist.

The set of images are analyzed by a language model (412). As discussed above, the set of images can be analyzed by a multi-modal language model that is configured to analyze a set of images and/or text and generate an output describing the set of images. For example, the language model can be a smaller language model having a P90 latency of five seconds or less, thereby enabling the creation of the output describing the set of images in five seconds or less at least 90% of the time. As discussed in more detail above, and below, a larger language model could be used to create a more accurate description of the set of images, but the latency could be up to 20 seconds or more, which results in slow chat interactions between the client device and the AI system.

To increase the accuracy of the descriptions of the images generated by the smaller language model, text previously submitted by the client device can also be used when evaluating the set of images. In some implementations, the text previously submitted by the client device can be a search query previously submitted by the client device, as discussed in detail with reference to FIG. 2. In these implementations, the search query provides a contextual queue that the language model can use to guide the generation of the description of the set of images. For example, assuming that the previously submitted search query (e.g., the search query that triggered presentation of the generated digital component) is related to moving, the language model can infer that the objects of interest that should be described in the set of images are those objects that are typically transported when a person moved from one residence to the other. In contrast, if the previously submitted search query was related to interior painting, the language model can infer that the objects of interest in the images are walls, cabinets, or other objects that are typically painted. In this way, the previously submitted search query can guide/constrain the analysis of the set of images and/or the generation of the description of the set of images created by the language model.

The output of the language model can be referred to as a summary of the images, as discussed with reference to FIG. 2, which is generated by the language model, and is a summary output describing visual attributes depicted by the set of images. In some implementations, the set of objects identified by the image classification model and the summary output of the language model are combined to create a combined description of the set of images.

A description of objects in the set of images is created based on (i) the list of objects obtained from the image classification model and (ii) the analysis of the set of images and text input (414). In some implementations, the description of the objects is created by generating a set of image/object description pairs, wherein each image/object description pair includes an image from the set of images and text specifying the objects depicted by the image. The creation of the list of objects can be performed, for example, as discussed in detail with reference to FIGS. 2-3. For brevity, that discussion is not repeated here.

A recommended offering is generated based on the description of the objects depicted by the set of images (416). In some implementations, the recommended offering is generated based on, and/or to include, one or more of a set of text reasons why the recommended offering is being provided, a uniform resource locator, and image, and/or resource text. The set of text reasons can be generated, for example, by the language model that is generating the recommended offering and can include an explanation as to the factors that led the model to create the recommended offering. In other words, why the recommended offering was provided. For example, in the moving truck example used previously, the language model can generate a set of text indicating that a particular size/type of moving truck was recommended based on the amount of space that will be occupied by the objects identified in the set of images.

In some implementations, the set of text reasons can be obtained from a text language model. For example, the image/object description pairs can be input into the text language model, and the set of text reasons (i) generated by the text language model and (ii) explaining why the recommended offering of the content provider was selected, can be obtained as output from the text language model. In some implementations, inputting the image/object description pairs into the text language model is performed while the continue user interface element is presented in the chat interface and before interaction with the continue user interface element is detected, as discussed with reference to 422-426 below.

With respect to the uniform resource locator, image, and resource text, each of these can be extracted from a second level domain of the content provider that offers the recommended offering (e.g., the moving company, in the example above). By extracting these items directly from the second level domain of the content provider (or another location specified by the content provider), rather than generating this content, the language model's output has a higher likelihood of generating a recommended offering that includes factual information (e.g., an accurate price, availability, and/or offering details), than if the language model was generating these details. The recommended offering can include any combination of the uniform resource locator, set of text reasons, the image, and the resource text.

The recommended offering is transmitted to the client device (418). As previously discussed, the recommended offering can be transmitted for presentation in the chat interface (e.g., via the established communications channel), or can be transmitted for presentation in another application or web page (e.g., in a designated slot). As such, the recommended offering is presented at the client device (420).

In some implementations, the set of image/object description pairs discussed above can be presented in the chat interface at the client device before creating the recommended offering (422). For example, as previously discussed, the image/object description pairs can be presented in the chat interface for review by the user of the client device. In this way, the user is provided an opportunity to review the object descriptions and ensure that they accurately characterize aspects of the images that are of interest to the user. Furthermore, presentation of the image/object description pairs can also cause/trigger presentation of a continue user interface element in the chat interface with the image/object description pairs. As discussed, above, the continue user interface element can be a continue button or another user interface element that is configured to trigger generation, transmission, and/or submission of data indicating that the user would like to proceed with the creation of a recommended offering using the presented image/object description pairs.

Interaction with the continue user interface element is detected (424). For example, as discussed above with reference to FIGS. 2-3, the interaction with the continue user interface element can be detected by receiving data indicative of interaction with the continue user interface element from the client device.

The chat interface transitions from a first state to a second state (426). In some implementations, the transition of the chat interface from the first state to the second state is performed in response to detecting the interaction with the continue user interface element. As previously discussed, the first state of the chat interface is a state in which the image/object description pairs are presented, and the second state is a state in which the recommended offering is presented. As discussed above with reference to FIGS. 2-3, the creation of the recommended offering can occur in parallel with presentation of the first state of the chat user interface, such that the elapsed time between user interaction with the continue user interface element and presentation of the recommended offering will be shorter than the elapsed time between interaction with the continue user interface element and presentation of the recommended offering when the recommended offering is created after interaction with the continue user interface element.

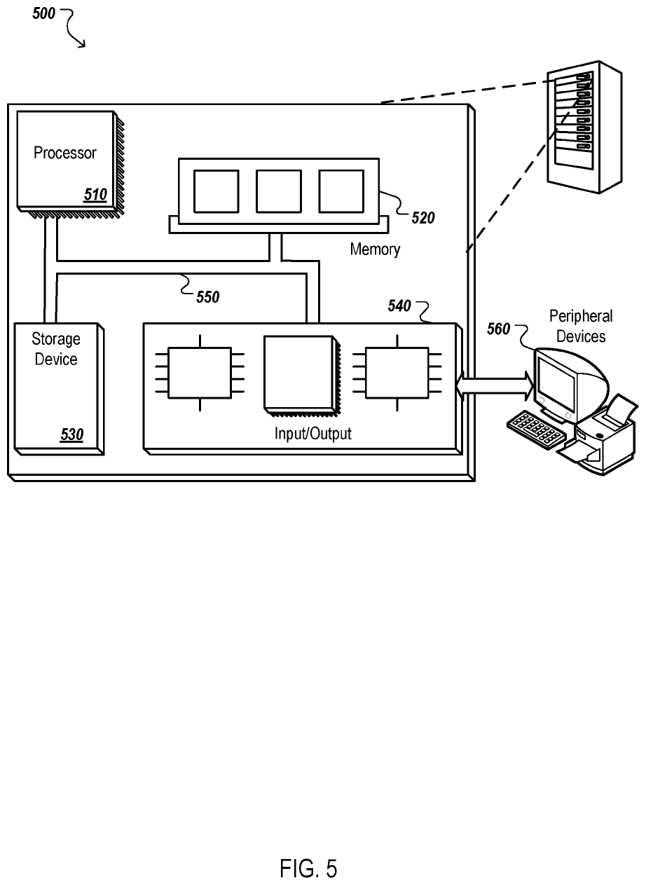

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read Only Memory), EEPROM (Electrically Erasable Programmable Read Only Memory) and flash memory devices; magnetic disks, e.g., internal hard disks or removable disks; magneto-optical disks; and CD-ROM (Compact Disc Read Only Memory) and DVD-Read Only Memory (Digital Video Disk Read Only Memory) disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
generating, by an artificial intelligence system, a digital component including a launch user interface element configured to invoke execution of a chat interface in response to user interaction with the launch user interface element;
detecting, by the artificial intelligence system, interaction with the launch user interface element;
establishing, by the artificial intelligence system, a communication channel with a client device at which the interaction with the launch user interface element occurred;
receiving, by the artificial intelligence system and through the chat interface, a set of images from the client device;
obtaining, from an image classification model, a list of objects depicted by the set of images;
analyzing, by a language model, the set of images and text input previously submitted by the client device;
creating a description of objects in the set of images based on (i) the list of objects obtained from the image classification model and (ii) the analysis of the set of images and text input;
generating, by the artificial intelligence system, a recommended offering of a content provider based on the description of the objects in the set of images; and
transmitting, by the artificial intelligence system, the recommended offering to the client device over the established communication channel.

2. The method of claim 1, further comprising:
generating a set of text reasons why the recommended offering of the content provider was provided;
extracting a uniform resource locator from a second level domain of the content provider;
extracting an image from the second level domain of the content provider;
extracting resource text from the second level domain of the content provider; and
generating the recommended offering based on a combination of the set of text reasons, the uniform resource locator, the image, and the resource text.

3. The method of claim 2, wherein creating the description of the objects comprises generating a set of image/object description pairs, wherein each image/object description pair includes an image from the set of images and text specifying the objects depicted by the image.

4. The method of claim 3, further comprising:
transmitting the set of image/object description pairs to the chat interface at the client device before creating the recommended offering;
causing presentation, in the chat interface with the image/object description pairs, a continue user interface element;
detecting interaction with the continue user interface element; and
causing the chat interface to transition from a first state in which the image/object description pairs are presented to a second state in which the recommended offering is presented, wherein the transition is caused in response to detecting the interaction with the continue user interface element.

5. The method of claim 4, further comprising inputting the image/object description pairs into a text language model, wherein generating the set of text reasons comprises obtaining, from the text language model, the set of text reasons why the recommended offering of the content provider was selected.

6. The method of claim 5, wherein inputting the image/object description pairs into the text language model is performed while the continue user interface element is presented in the chat interface and before interaction with the continue user interface element is detected.

7. The method of claim 1, wherein analyzing, by a language model, the set of images and the text input previously submitted by the client device comprises generating, by the language model a summary output describing visual attributes depicted by the set of images, the method further comprising:
combining the summary output and the set of objects to create a combined description of the set of images.

8. An artificial intelligence (“AI”) system comprising:
one or more memory devices; and
one or more computing devices configured to interface with the one or more memory devices and execute instructions that cause the artificial intelligence system to perform operations comprising:
generating a digital component including a launch user interface element configured to invoke execution of a chat interface in response to user interaction with the launch user interface element;
detecting interaction with the launch user interface element;
establishing a communication channel with a client device at which the interaction with the launch user interface element occurred;
receiving, through the chat interface, a set of images from the client device;
obtaining, from an image classification model, a list of objects depicted by the set of images;
analyzing, by a language model, the set of images and text input previously submitted by the client device;
creating a description of objects in the set of images based on (i) the list of objects obtained from the image classification model and (ii) the analysis of the set of images and text input;
generating a recommended offering of a content provider based on the description of the objects in the set of images; and
transmitting the recommended offering to the client device over the established communication channel.

9. The AI system of claim 8, wherein the instructions cause the one or more computing devices to perform operations further comprising:
generating a set of text reasons why the recommended offering of the content provider was provided;
extracting a uniform resource locator from a second level domain of the content provider;
extracting an image from the second level domain of the content provider;
extracting resource text from the second level domain of the content provider, and
generating the recommended offering based on a combination of the set of text reasons, the uniform resource locator, the image, and the resource text.

10. The AI system of claim 9, wherein creating the description of the objects comprises generating a set of image/object description pairs, wherein each image/object description pair includes an image from the set of images and text specifying the objects depicted by the image.

11. The AI system of claim 10, wherein the instructions cause the one or more computing devices to perform operations further comprising:
transmitting the set of image/object description pairs to the chat interface at the client device before creating the recommended offering;
causing presentation, in the chat interface with the image/object description pairs, a continue user interface element;
detecting interaction with the continue user interface element; and
causing the chat interface to transition from a first state in which the image/object description pairs are presented to a second state in which the recommended offering is presented, wherein the transition is caused in response to detecting the interaction with the continue user interface element.

12. The AI system of claim 11, wherein the instructions cause the one or more computing devices to perform operations further comprising inputting the image/object description pairs into a text language model, wherein generating the set of text reasons comprises obtaining, from the text language model, the set of text reasons why the recommended offering of the content provider was selected.

13. The AI system of claim 12, wherein inputting the image/object description pairs into the text language model is performed while the continue user interface element is presented in the chat interface and before interaction with the continue user interface element is detected.

14. The AI system of claim 8, wherein:
analyzing, by a language model, the set of images and the text input previously submitted by the client device comprises generating, by the language model a summary output describing visual attributes depicted by the set of images; and
the instructions cause the one or more computing devices to perform operations further comprising combining the summary output and the set of objects to create a combined description of the set of images.

15. A non-transitory computer readable medium storing instructions that, upon execution by one or more data processing apparatus of an artificial intelligence system, cause the artificial intelligence system to perform operations comprising:
generating a digital component including a launch user interface element configured to invoke execution of a chat interface in response to user interaction with the launch user interface element;
detecting interaction with the launch user interface element;
establishing a communication channel with a client device at which the interaction with the launch user interface element occurred;
receiving, through the chat interface, a set of images from the client device;
obtaining, from an image classification model, a list of objects depicted by the set of images;
analyzing, by a language model, the set of images and text input previously submitted by the client device;
creating a description of objects in the set of images based on (i) the list of objects obtained from the image classification model and (ii) the analysis of the set of images and text input;
generating a recommended offering of a content provider based on the description of the objects in the set of images; and
transmitting the recommended offering to the client device over the established communication channel.

16. The non-transitory computer readable medium of claim 15, wherein the instructions cause the one or more data processing apparatus to perform operations further comprising:
generating a set of text reasons why the recommended offering of the content provider was provided;
extracting a uniform resource locator from a second level domain of the content provider;
extracting an image from the second level domain of the content provider;
extracting resource text from the second level domain of the content provider; and
generating the recommended offering based on a combination of the set of text reasons, the uniform resource locator, the image, and the resource text.

17. The non-transitory computer readable medium of claim 16, wherein creating the description of the objects comprises generating a set of image/object description pairs, wherein each image/object description pair includes an image from the set of images and text specifying the objects depicted by the image.

18. The non-transitory computer readable medium of claim 17, wherein the instructions cause the one or more data processing apparatus to perform operations further comprising:
transmitting the set of image/object description pairs to the chat interface at the client device before creating the recommended offering;
causing presentation, in the chat interface with the image/object description pairs, a continue user interface element;
detecting interaction with the continue user interface element; and
causing the chat interface to transition from a first state in which the image/object description pairs are presented to a second state in which the recommended offering is presented, wherein the transition is caused in response to detecting the interaction with the continue user interface element.

19. The non-transitory computer readable medium of claim 18, wherein the instructions cause the one or more data processing apparatus to perform operations further comprising inputting the image/object description pairs into a text language model, wherein generating the set of text reasons comprises obtaining, from the text language model, the set of text reasons why the recommended offering of the content provider was selected.

20. The non-transitory computer readable medium of claim 19, wherein inputting the image/object description pairs into the text language model is performed while the continue user interface element is presented in the chat interface and before interaction with the continue user interface element is detected.
